(19) United States
(12) Patent Application Publication
(10) Pub. No.: US 2008/0161141 A1
(43) Pub. Date: Jul. 3, 2008

(54) Water pump pulley for cooling system of vehicle

(76) Inventors: Jang-Hyuk Joo, Daegu-city (KR); Jae-Duk Jang, Daegu-city (KR); In-Sik Joo, Daegu-city (KR)

Correspondence Address: Pearl Cohen Zedek Latzer, LLP, 1500 Broadway, 12th Floor, New York, NY, 10036, US

(21) Appl. No.: 11/783,896

(22) Filed: Apr. 12, 2007

(30) Foreign Application Priority Data
Dec. 27, 2006 (KR) 10-2006-0135245
Dec. 27, 2006 (KR) 10-2006-0135246

(51) Int. Cl. F16H 55/00

(52) U.S. Cl. 474/8

(57) ABSTRACT

A water pump pulley for a cooling system for a vehicle is provided. The water pump pulley for a cooling system of a vehicle includes an outer rotational member formed of thermoplastic resin, the outer rotational member being provided at an outer circumference with one or more V-shaped circumferential grooves and at a central portion with a space and an inner rotational member integrally coupled to the space of the outer rotational member through an insert injection molding process and provided with bolt holes for connecting to a rotational shaft of a water pump side. The outer rotational member is provided at one or both of opposite surfaces with a plurality of reinforcing ribs. The inner rotational member is provided with a slip preventing member for enhancing integration with the outer rotational member and dispersing force.

### CROSS-REFERENCE TO RELATED APPLICATION

This application claims priority to and the benefit of Korean Patent Application Nos. 10-2006-013245 and 10-2006-0135246 filed in the Korean Intellectual Property Office on Dec. 27, 2006, the contents of which are incorporated herein by reference in their entirety.

### FIELD OF THE INVENTION

The present invention relates to a water pump pulley for cooling system of a vehicle. More particularly, the present invention relates to a water pump pulley that is significantly reduced in a weight and can be manufactured through a simple manufacturing process.

### BACKGROUND OF THE INVENTION

Generally, cooling systems are used for cooling a vehicle engine.

Among the cooling systems for vehicles, a water-cooling system is configured to perform the cooling function by allowing cooling water to circulate through water jackets provided on a cylinder block/head of the vehicle engine.

As described above, in order to circulate the cooling water, the water-cooling system includes a pump housing, an impeller rotatably installed in the pump housing, and a power transmission member connecting the impeller to a water pump pulley rotating by a separated driving unit.

In order to manufacture the conventional water pump pulley, a casting process is first performed to make a pulley body and a forging process is performed to process the pulley body in a predetermined shape. Finally, a process for forming V-shaped circumferential grooves on the pulley body formed in the predetermined shape is performed.

As described above, since the conventional water pump pulley is manufactured through a variety of processes, the productivity is deteriorated and the manufacturing costs increase.

Further, the conventional water pump pulley is made of iron. This causes the increase in a weight of the cooling system.

Furthermore, since the conventional water pump pulley is limited in designing a shape thereof due to characteristics of the mechanical process and forming process, it is difficult to diversify the shape thereof.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a water pump pulley having advantages of reducing in a weight and being manufactured through a simple manufacturing process.

An exemplary embodiment of the present invention provides a water pump pulley for a cooling system of a vehicle, including an outer rotational member formed of thermoplastic resin, the outer rotational member being provided at an outer circumference with one or more V-shaped circumferential grooves and at a central portion with a space and an inner rotational member integrally coupled to the space of the outer rotational member through an insert injection molding process and provided with bolt holes for connecting to a rotational shaft of a water pump side.

The outer rotational member may be provided at one or both of opposite surfaces with a plurality of reinforcing ribs.

The inner rotational member has a wave-shaped outer circumference to enhance integration with the outer rotational member and dispersing force.

The reinforcing ribs extend from a rotation center side to an outer circumference side and protrude from a side surface of the outer rotational member.

The inner rotational member may be formed of metal plate.

The reinforcing ribs may contain 40-65 parts by volume of glass fiber.

The outer rotational member may be formed of polyamide-based thermoplastic resin.

### BRIEF DESCRIPTION OF THE DRAWINGS

FIG. 1 is a partly cut-away perspective view of a water pump pulley coupled to a water pump according to an exemplary embodiment of the present invention.

FIG. 2 is a perspective view of an outer rotational member of the water pump pulley of FIG. 1.

FIG. 3 is a front view of the water pump pulley of FIG. 1.

FIG. 4 is a cross-sectional view of the water pump pulley of FIG. 1.

FIGS. 5A and 5B are views of examples of an inner rotational member of the water pump pulley of FIG. 1.

FIG. 6 is a view of another example of an inner rotational member of the water pump pulley of FIG. 1.

FIG. 7 is a detailed view of FIG. 6.

### DETAILED DESCRIPTION OF THE EMBODIMENTS

Exemplary embodiments of the present invention will now be described with reference to the accompanying drawings.

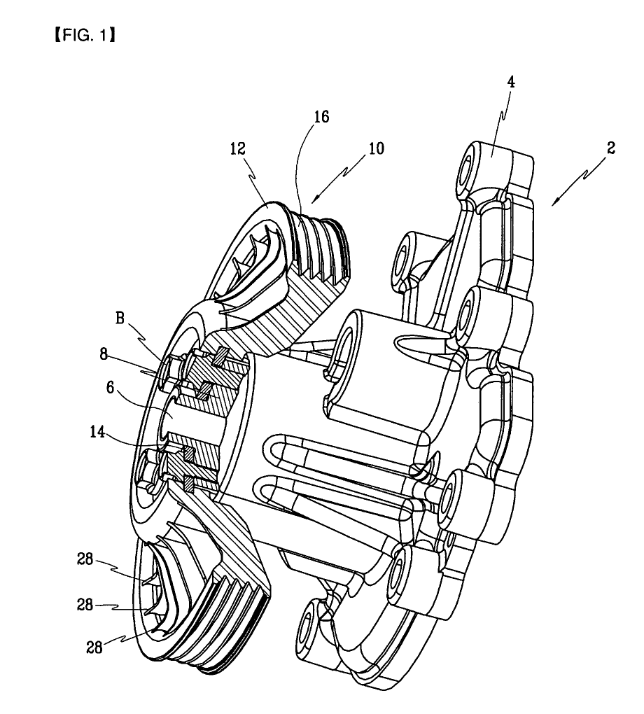

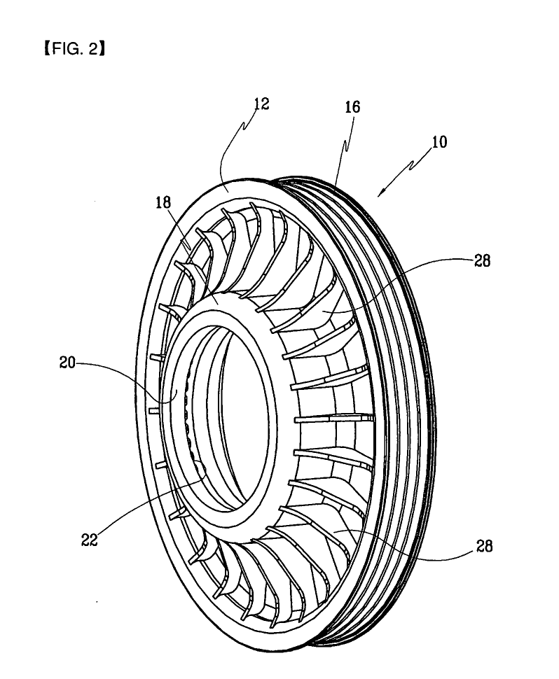

FIG. 1 is a partly cut-away perspective view of a water pump pulley coupled to a water pump according to an exemplary embodiment of the present invention, and FIG. 2 is a perspective view of an outer rotational member of the water pump pulley of FIG. 1.

A water pump assembly 2 includes a pump housing 4 and a power transmission member 6 that is connected to an impeller (not shown) rotatably installed in the pump housing 4 to rotate together with the impeller.

The power transmission member 6 extends outward from the pump housing 4 and an outward flange 8 is provided on an extending portion of the power transmission member 6.

The outward flange 8 is configured to be coupled to a water pump pulley 10.

The water pump pulley 10 is divided into an outer rotational member 12 and an inner rotational member 14. The outward flange 8 is coupled to the inner rotational member 14.

The outer rotational member 12 according to the present exemplary embodiment of the present invention is formed of polyamide-based thermoplastic resin through an injection molding process.

The outer rotational member 12 is provided at an outer circumference with one or more V-shaped circumferential grooves 16 and at a center portion with a boss 18 defining a space 20.

The space 20 is formed in a circular shape and the boss 18 is provided at an inner wall defining the space 20 with an insert groove 22.

Substantially, the insert groove 22 is formed by inserting the inner rotational member 14 during the injection molding process for forming the water pump pulley 10.

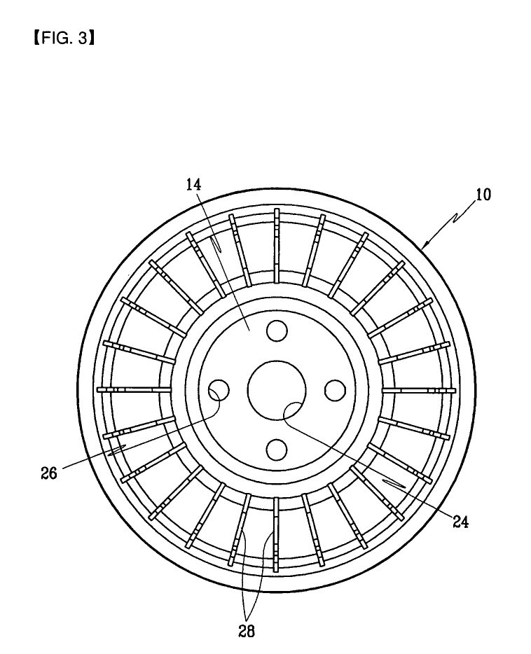

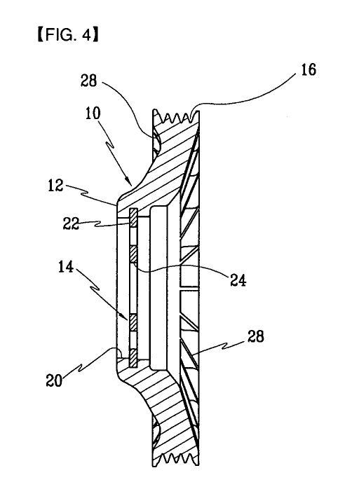

As shown in FIGS. 3 and 4, the inner rotational member 14 is inserted in the insert groove 22 such that the inner and outer rotational members 12 and 14 are integrated with each other.

The inner rotational member 14 may be formed of a metal plate having an excellent corrosion-resistance and excellent stiffness. The inner rotational member 14 is provided at a central portion with a central hole 24 through which the power transmission member 6 passes.

Further, the inner rotational member 14 is provided with a plurality of peripheral holes 26 so that the outer flange 8 of the power transmission member 6 is coupled by bolts B inserted through the peripheral holes 26 in a state where the outward flange 8 is inserted in the central hole 24.

As shown in FIGS. 1, 2, 3, and 4, the outer rotation member 12 is provided at opposite surfaces with a plurality of ribs 28 to enhance structural stiffness thereof.

The ribs 28 extend from the boss 18 in a radial direction.

The ribs 28 may be formed of a material same as that of the outer rotational member 12 so that they can be formed together with the outer rotational member through the injection molding process.

In order to further improve the structural rigidity of the outer rotational member 12 and the ribs 28, they contain 40-65 parts by volume of glass fiber.

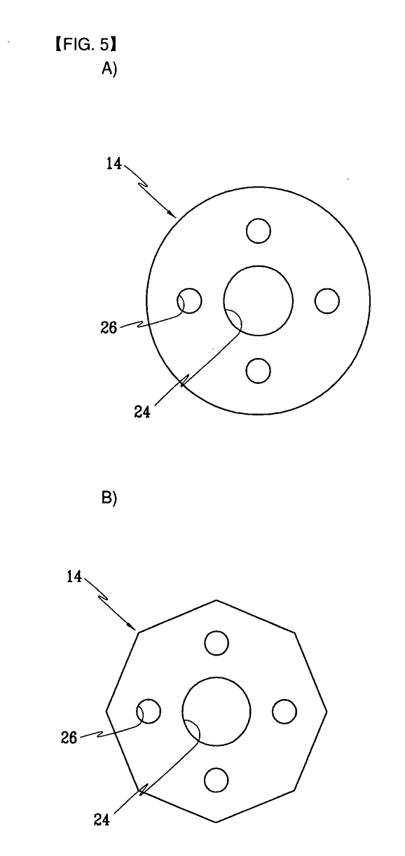

FIGS. 5A and 5B show examples of the inner rotational member applied to the water pump pulley of the present embodiment of the present invention. An outer circumference of the inner rotational member 14 is formed in a circular shape (see FIG. 5A).

Alternatively, the outer circumference of the inner rotational member 14 may be formed in a polygonal shape (see FIG. 5B).

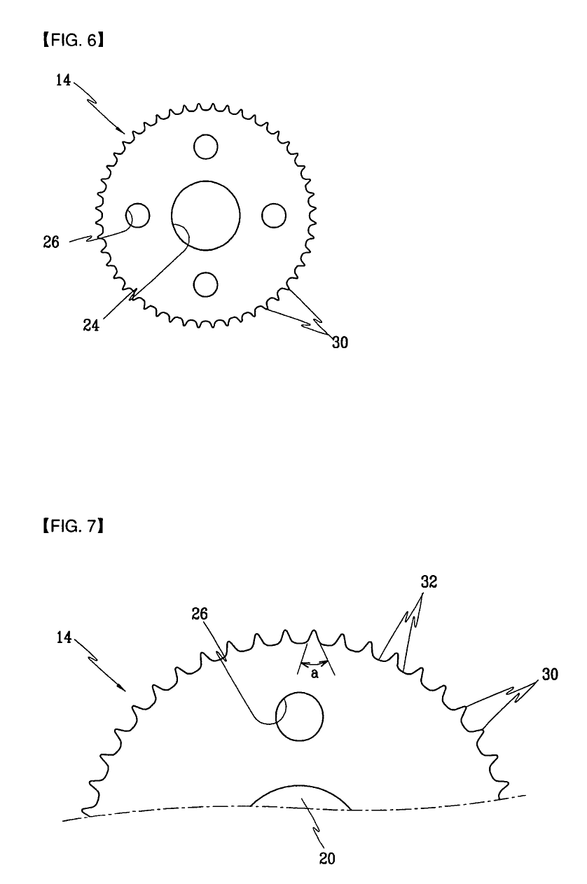

FIG. 6 shows another example of the inner rotational member 14 applied to the water pump pulley of the present exemplary embodiment.

An inner rotational member 14 of this example is provided at an outer circumference with a plurality of slip preventing protrusions 30 that can enhance an integration with the outer rotational member 12.

The slip preventing projections 30 extend from the outer circumference of the inner rotational member 14. A width of each slip preventing protrusions 30 is gradually reduced as it goes away from the outer circumference of the inner rotational member 14.

As shown in FIG. 7, an angle (a) defined between both sides of each of the slip preventing protrusion 30 ranges from 40° to 45°.

The angle (a) between the both sides of the protrusion is designed to effectively disperse a resistance force that is generated when rotating the impeller (not shown) installed in the pump housing 4 through the power transmission member 6 passing through the central hole 24 formed in the inner rotational member 14.

That is, since the pulley of the present exemplary embodiment of the present invention is divided into the outer and inner rotational members and the inner rotational member is integrated with the outer rotational member through the insert injection molding process, a slip may occur between the outer and inner rotational members 12 and 14 at the insert groove 22 formed on the outer rotational member 12.

Therefore, in order to prevent the occurrence of the slip, the slip preventing protrusions 30 and the slip preventing grooves 32 are formed at a periphery portion of the inner rotational member 14.

In the water pump pulley according to the present exemplary embodiment, since the outer rotational member is formed of the thermoplastic resin through the injection molding process, the weight thereof can be significantly reduced and the flexibility in designing thereof can be enhanced.

In addition, since the inner rotational member formed of a metal plate is integrated with the central portion of the outer rotational member through the insert injection molding process, the durability can be more improved as compared with a case where the water pump pulley is formed of only synthetic resin.

As those skilled in the art would realize, the described embodiments may be modified in various different ways, all without departing from the spirit or scope of the present invention.

In the water pump pulley according to the present invention, since the water pump pulley is divided into an outer portion and an inner portion that are respectively formed of thermoplastic resin and metal, an overall weight of the water pump pulley is reduced. Further, the use of the thermoplastic resin enhances the flexibility in designing the water pump pulley and reduces the manufacturing costs. Particularly, since the outer portion of the water pump pulley is made through the injection molding process, there is no need for a special process for forming the V-shaped circumferential grooves, thereby simplifying the manufacturing process.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A water pump pulley for a cooling system of a vehicle, comprising:
a. an outer rotational member formed of thermoplastic resin, the outer rotational member being provided at an outer circumference with one or more V-shaped circumferential grooves and at a central portion with a space; and
b. an inner rotational member integrally coupled to the space of the outer rotational member through an insert injection molding process and provided with bolt holes for connecting to a rotational shaft of a water pump side.

2. The water pump pulley of claim 1, wherein the outer rotational member is provided at one or both of opposite surfaces with a plurality of reinforcing ribs.

3. The water pump pulley of claim 1, wherein the inner rotational member is provided with slip preventing means for enhancing integration with the outer rotational member and dispersing force.

4. The water pump pulley of claim 1, wherein the inner rotational member is formed of metal plate.

5. The water pump pulley of claim 2, wherein the reinforcing ribs contain 40-65 parts by volume of glass fiber.

6. The water pump pulley of claim 1, wherein the outer rotational member is formed of polyamide-based thermoplastic resin.

7. The water pump pulley of claim 3, wherein the slip preventing means includes slip preventing protrusions formed on an outer circumference of the inner rotational member.

8. The water pump pulley of claim 7, wherein each of the slip preventing protrusions has a width that is gradually reduced as it goes away from the outer circumference of the inner rotational member.

9. The water pump pulley of claim 7, wherein an angle between both sides of each of the slip preventing protrusions ranges from 40° to 45°.
